(19) United States
(12) Patent Application Publication
(10) Pub. No.: US 2012/0026126 A1
(43) Pub. Date: Feb. 2, 2012

(54) CAPACITIVE TOUCH SCREEN

(75) Inventors: Ho Joon Park, Seoul (KR); Kwang Soo Yoon, Gyunggi-do (KR); Jong Young Lee, Gyunggi-do (KR)

(73) Assignee: SAMSUNG ELECTRO-MECHANICS CO., LTD., Gyunggi-do (KR)

(21) Appl. No.: 12/912,091

(22) Filed: Oct. 26, 2010

(30) Foreign Application Priority Data
Jul. 27, 2010 (KR) 1020100072311

(51) Int. Cl. G06F 3/045

(52) U.S. Cl. 345/174

(57) ABSTRACT

Disclosed herein is a capacitive touch screen, including: a base member; a plurality of electrode patterns formed on one surface of the base member and made of a conductive polymer; and electrode wirings connected to the electrode patterns and sensing a change in capacitance, wherein a color of the base member corresponds to a unique color of the conductive polymer.

### CROSS REFERENCE TO RELATED APPLICATION

This application claims the benefit of Korean Patent Application No. 10-2010-0072311, filed on Jul. 27, 2010, entitled “Capacitive Touch Screen”, which is hereby incorporated by reference in its entirety into this application.

### BACKGROUND OF THE INVENTION

1. Technical Field

The present invention relates to a capacitive touch screen.

2. Description of the Related Art

With the development of the mobile communication technology, user terminals such cellular phones, PDAs, and navigations can serve as a display unit that simply displays character information as well as a unit for providing various and complex multi-media such as audio, moving picture, radio internet web browser, etc. Therefore, electronic information terminals having a limited size require a larger display screen, such that a display device using a touch screen has become the main focus.

The touch screen combines a screen and coordinate input units, thereby saving space as compared to a key input scheme according to the prior art. Therefore, a display apparatus recently developed uses a touch screen in order to more improve a screen size and user convenience.

The touch screen is classified into a resistive type and a capacitive type. The resistive touch screen includes a pair of base members that are spaced apart from each other by a spacer having an opening formed inside thereof and have resistive films formed on opposite surfaces, and sensing electrodes that are formed in outer regions of the resistive films to sense a change in voltage generated from the resistive films. The capacitive type is classified into a self capacitive touch screen and a mutual capacitive touch screen. The self capacitive touch screen includes a base member having a plurality of electrode patterns formed on one surface thereof and detects a change in capacitance generated from the electrode patterns when the touch screen is touched by an input unit from the outside to calculate coordinates of the touched points. In such a self capacitive touch screen having a single layer structure, each of the electrode patterns has unique coordinate information. In addition, the mutual capacitive touch screen includes a base member having a plurality of electrode patterns formed on opposite surfaces with different directionalities and a spacer spatially separating the electrode patterns, and detects a mutual change in capacitance generated from the electrode patterns separated and disposed when the touch screen is touched by an input unit from the outside to calculate the coordinates of the touched points.

Reviewing the touch screens according to the prior art, in the resistive touch screen, a conductive material is applied over the base member, thereby not causing a problem. However, in the capacitive touch screen, the electrode patterns are formed by patterning a conductive material with a unique color and the base member is made of a transparent material, thereby causing a visibility problem in that the electrode pattern is recognized distinctively from the base member.

Such a visibility problem is noticeable at the edge regions of the electrode patterns and it becomes more serious when the electrode pattern is made of a conductive polymer. The conductive polymer is advantageous in view of low manufacturing costs as compared to the known metal oxide such ITO but is disadvantageous in view of low transparency.

### SUMMARY OF THE INVENTION

The present invention has been made in an effort to provide a capacitive touch screen in which electrode patterns are made of a conductive polymer and a color of a base member corresponds to a unique color of the conductive polymer to reduce visibility of the electrode patterns, different from a capacitive touch screen according to the prior art in which a base member made of a transparent material is used in order to improve light transmittance.

A capacitive touch screen according to a preferred embodiment of the present invention includes: a base member; a plurality of electrode patterns formed on one surface of the base member and made of a conductive polymer; and electrode wirings connected to the electrode patterns and sensing a change in capacitance, wherein a color of the base member corresponds to a unique color of the conductive polymer.

Brightness of the base member corresponds to unique brightness of the electrode pattern or chroma of the base member corresponds to unique chroma of the electrode pattern.

The base member is a glass substrate or a film substrate.

The conductive polymer is any one of polythiophene, polypyrrole, polyaniline, polyacetylene and polyphenylene polymers.

The capacitive touch screen further includes a protective layer covering the electrode patterns and the electrode wirings.

A capacitive touch screen according to a preferred embodiment of the present invention includes: a base member; a plurality of electrode patterns formed on one surface of the base member and made of a conductive polymer; a compensation layer formed on one surface of the base member and having a color corresponding to a unique color of the conductive polymer; and electrode wirings connected to the electrode patterns and sensing a change in capacitance.

The compensation layer is formed over one surface of the base member and the electrode patterns are formed on the compensation layer.

Brightness of the compensation layer corresponds to unique brightness of the electrode pattern or chroma of the compensation layer corresponds to unique chroma of the electrode pattern.

The base member is a glass substrate or a film substrate.

The conductive polymer is any one of polythiophene, polypyrrole, polyaniline, polyacetylene and polyphenylene polymers.

### BRIEF DESCRIPTION OF THE DRAWINGS

FIG. 1 is a plan view of a capacitive touch screen according to a first preferred embodiment of the present invention;

FIG. 2 is a cross-sectional view of the capacitive touch screen of FIG. 1;

FIG. 3 is a cross-sectional view showing a modified example of the capacitive touch screen of FIGS. 1 and 2;

FIG. 4 is a plan view showing another modified example of the capacitive touch screen of FIGS. 1 and 2;

FIG. 5 is a plan view of a capacitive touch screen according to a second preferred embodiment of the present invention;

FIG. 6 is a cross-sectional view of the capacitive touch screen of FIG. 5; and

FIG. 7 is a cross-sectional view showing a modified example of the capacitive touch screen of FIGS. 5 and 6.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

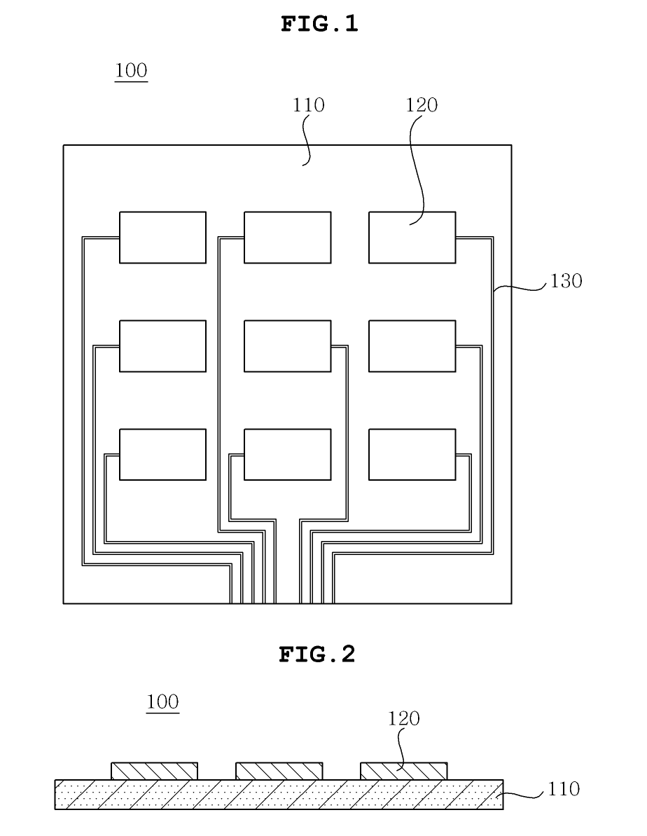

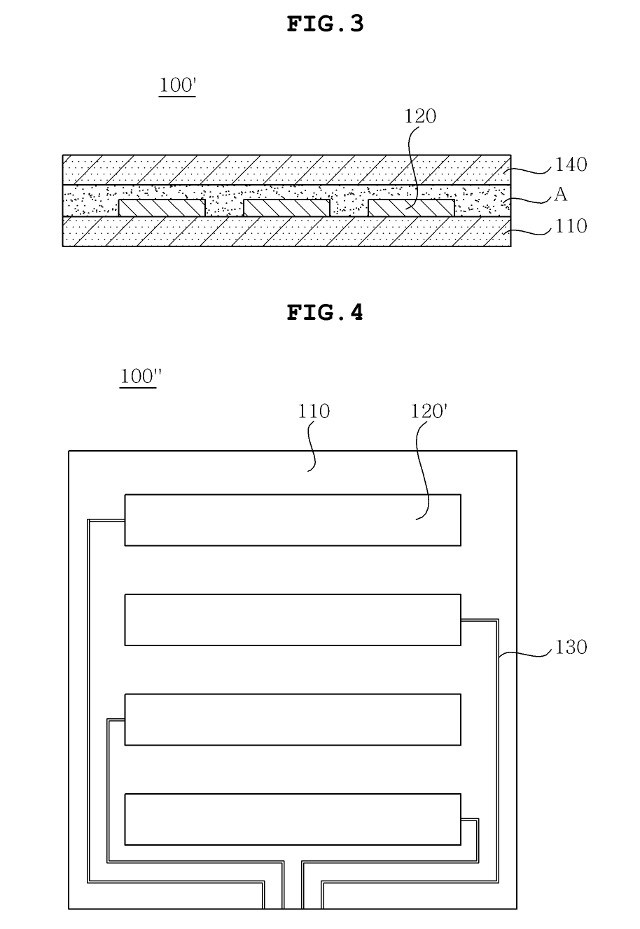

FIG. 1 is a plan view of a capacitive touch screen according to a first preferred embodiment of the present invention, FIG. 2 is a cross-sectional view of the capacitive touch screen of FIG. 1, and FIGS. 3 and 4 show modified examples of the capacitive touch screen of FIGS. 1 and 2. Hereinafter, a capacitive touch screen (hereinafter, referred to as a touch screen) according to the present embodiment will be described with reference to these figures.

A touch screen 100 according to the present embodiment uses a base member 110 including pigment to reduce visibility of electrode patterns 120 having a unique blue color.

The base member 110 may include the electrode patterns 120 formed on one surface thereof and may use a glass substrate or a film substrate. Among others, the film substrate may be made of polyethyleneterephthalate (PET), polymethylmethacrylate (PMMA), polypropylene (PP), polyethylene (PE), polyethylenenaphthalate (PEN), polycarbonate (PC), polyethersulfone (PES), polyimide (PI), polyvinyl alcohol (PVA), cyclic olefin copolymer (COC), styrene polymer, and so on, but is not particularly limited thereto.

The plurality of electrode patterns 120 formed on the base member 110 are made of a conductive polymer. The conductive polymer may adopt an organic compound, such as polythiophene, polypyrrole, polyaniline, polyacetylene, polyphenylene, or the like. In particular, among the polythiophene, poly-3,4-ethylenedioxythiophene/polystyrenesulfonate (PEDOT/PSS) compound is most preferable and at least one of the organic compounds may be mixed.

As shown in FIGS. 1 and 2, when the touch screen 100 is a self capacitive type, the plurality of electrode patterns 120 are separately formed and have unique coordinate values. The electrode patterns shown in FIGS. 1 and 2 may be modified to have a rectangular shape or another polygonal shape.

In addition, electrode wirings 130 connected to the electrode patterns 120 are formed on the base member 110. The electrode wiring 130 connected to the electrode pattern 120 may be made of a conductive material (for example, silver (Ag) paste) and be disposed to be collected at one side of the base member 110.

The conductive polymer configuring the electrode pattern 120 has a unique color. At this time, the unique color may be partially different depending on the component of the conductive polymer but is generally tinged with blue. The unique color of the electrode pattern 120 may be defined by a L*a*b color system distinguishing colors by brightness, color, and chroma.

First, in order to reduce visibility of the electrode patterns 120 formed on the base member 110, it is preferable that the color of the base member 110 corresponds to the unique color of the electrode pattern 120. Even though the color of the base member 110 is not completely the same as the color of the electrode pattern 120, if it is recognized as the color corresponding thereto, the electrode pattern 120 and the base member 110 may be recognized as a single member, such that the visibility of the electrode pattern 120 is reduced.

In addition, when the brightness or the chroma of the base member 110 corresponds to the unique brightness or the unique chroma of the electrode pattern 120, the visibility of the electrode pattern 120 is further reduced. When the brightness or the chroma is the same on the assumption that the colors are the same among the three factors distinguishing the colors, the colors of the base member 110 and the electrode pattern 120 become more alike to each other. When both the brightness and the chroma are the same, the colors of the base member 110 and the electrode pattern 120 become the same.

The base member 110 is manufactured by including pigment so that the color of the base member 110 such as a glass substrate and a film substrate corresponds to the unique color of the electrode pattern 120 made of the conductive polymer. As the pigment, colored inorganic pigment, organic pigment, dyes, or the like may be used.

In this case, in a touch screen 100′ a protective layer 140 that covers electrode patterns 120 and electrode wirings 130 is stacked on a base member 110, as shown in FIG. 3. The protective layer 140 may be made of the same material as the base member 110 and be stacked on the base member 110 by an optically clear adhesive. The protective layer 140 functions as dielectrics generating capacitance when the touch screen is touched by an input unit.

As shown in FIG. 4, the touch screen 100″ may be implemented according to a mutual capacitive type. The mutual capacitive touch screen 100″ also has a configuration similar to that of the self capacitive touch screen.

However, as shown in FIG. 4, a plurality of electrode patterns 120′ are formed in parallel, having directionality, wherein each of the electrode patterns 120′ has a rectangular bar shape. In addition, another base member as shown in FIG. 4 is disposed to be spaced apart from the base member by a spacer, such that the electrode patterns have a two-layer structure.

The electrode patterns formed on another base member are generally formed to be longitudinal to the electrode patterns shown in FIG. 4. The electrode patterns are not limited to have a bar shape but may be modified.

In the mutual capacitive touch screen 100″, the electrode pattern is also made of a conductive polymer and the base member 110 has a color corresponding to the unique color of the conductive polymer, thereby reducing visibility of the electrode pattern.

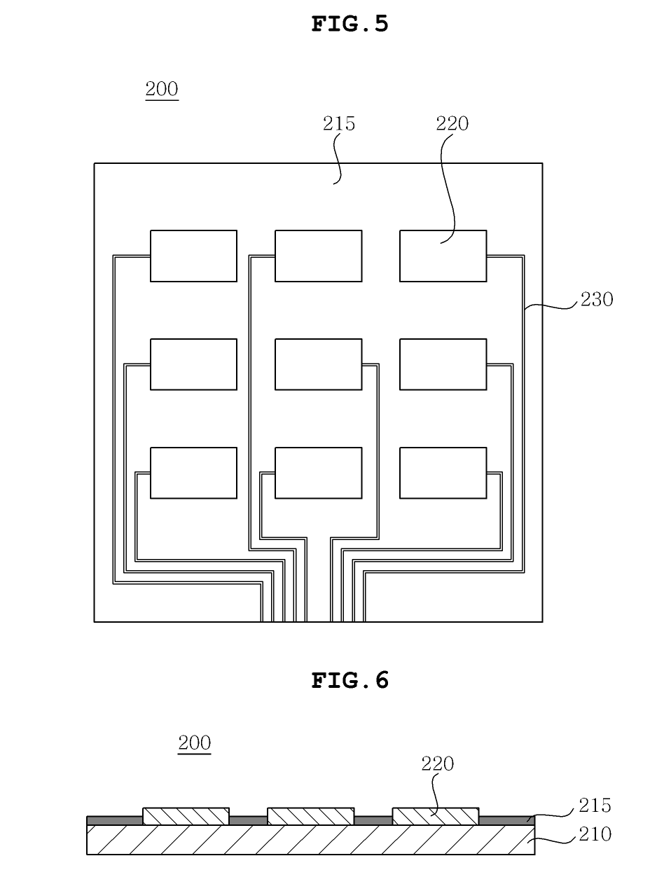

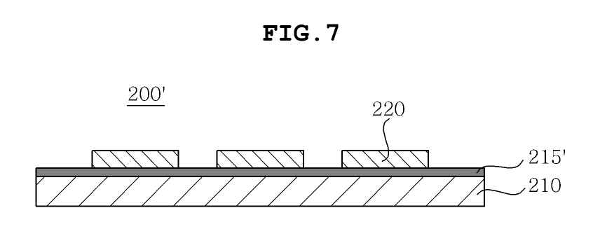

FIG. 5 is a plan view of a capacitive touch screen according to a second preferred embodiment of the present invention, FIG. 6 is a cross-sectional view of the capacitive touch screen of FIG. 5, and FIG. 7 shows a modified example of the capacitive touch screen of FIGS. 5 and 6. Hereinafter, a capacitive touch screen (hereinafter, referred to as a touch screen) according to the present embodiment will be described with reference to these figures.

In a touch screen 200 according to the present embodiment, a color of a base member 210 does not correspond to a unique color of an electrode pattern but a compensation layer 215 having a color corresponding to the unique color of the electrode pattern 220 is formed on one surface of the base member 210, different from the touch screen as shown in FIGS. 1 to 4. The touch screen 200 can be more simply manufactured, while obtaining the same effects, as compared to the case in which the color of the base member is changed by adding pigment to the base member.

As shown in FIGS. 5 and 6, the compensation layer 215 having a color corresponding to the unique color of the electrode pattern 220 made of a conductive polymer is formed on one surface of the base member 210 on which the electrode pattern 220 is formed. The compensation layer 215 is formed by applying pigment to a region on which the electrode patterns 220 are not formed.

In addition, it is more preferable that the brightness or the chroma of the compensation layer 215 corresponds to the unique brightness or the unique chroma of the electrode pattern 220, in order to reduce visibility of the electrode pattern 220. The color, brightness, and chroma of the compensation layer 215 are determined by pigment.

The base member 210 of the touch screen 200 as shown in FIGS. 5 and 6 may also be configured of a film substrate or a glass substrate. In addition, the touch screen 200 may be modified according to a mutual capacitive type as described with reference to FIG. 4.

FIG. 7 shows a modified example of the touch screen of FIGS. 5 and 6. A compensation layer 215′ of a touch screen 200′ shown in FIG. 7 is formed over one surface of the base member 210 and electrode patterns 220 are formed on the compensation layer 215′.

As compared with the touch screen shown in FIGS. 5 and 6, the touch screen 200′ has a structure in which the compensation layer 215′ is disposed between the electrode pattern 220 and the base member 210. The touch screen 200′ forms the compensation layer 215′ on one surface of the base member 210 and then forms the electrode patterns 220, such that it can be simply manufactured. Different from the touch screen shown in FIGS. 5 and 6, the touch screen 200′ previously prevents the possibility of pigment to be applied to the electrode pattern 220.

According to the present invention, the electrode patterns are made of the conductive polymer, making it possible to lower manufacturing costs of the touch screen.

In addition, the present invention uses the base member having a color corresponding to a unique color of the electrode pattern, thereby making it possible to solve the visibility problem in that the electrode pattern is recognized distinctively therefrom.

In addition, the present invention can obtain equivalent effects, without controlling the refractive index in order to improve visibility, different from the prior art.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A capacitive touch screen, comprising:
a base member;
a plurality of electrode patterns formed on one surface of the base member and made of a conductive polymer; and
electrode wirings connected to the electrode patterns and sensing a change in capacitance,
wherein a color of the base member corresponds to a unique color of the electrode pattern.

2. The capacitive touch screen as set forth in claim 1, wherein brightness of the base member corresponds to unique brightness of the electrode pattern or chroma of the base member corresponds to unique chroma of the electrode pattern.

3. The capacitive touch screen as set forth in claim 1, wherein the base member is a glass substrate or a film substrate.

4. The capacitive touch screen as set forth in claim 1, wherein the conductive polymer is any one of polythiophene, polypyrrole, polyaniline, polyacetylene and polyphenylene polymers.

5. The capacitive touch screen as set forth in claim 1, further comprising a protective layer covering the electrode patterns and the electrode wirings.

6. A capacitive touch screen, comprising:
a base member;
a plurality of electrode patterns formed on one surface of the base member and made of a conductive polymer;
a compensation layer formed on one surface of the base member and having a color corresponding to a unique color of the electrode pattern; and
electrode wirings connected to the electrode patterns and sensing a change in capacitance.

7. The capacitive touch screen as set forth in claim 6, wherein the compensation layer is formed over one surface of the base member and the electrode patterns are formed on the compensation layer.

8. The capacitive touch screen as set forth in claim 6, wherein brightness of the compensation layer corresponds to unique brightness of the electrode pattern or chroma of the compensation layer corresponds to unique chroma of the electrode pattern.

9. The capacitive touch screen as set forth in claim 6, wherein the base member is a glass substrate or a film substrate.

10. The capacitive touch screen as set forth in claim 6, wherein the conductive polymer is any one of polythiophene, polypyrrole, polyaniline, polyacetylene and polyphenylene polymers.

11. The capacitive touch screen as set forth in claim 6, further comprising a protective layer covering the electrode patterns and the electrode wirings.
